(19) United States
(12) Patent Application Publication
(10) Pub. No.: US 2016/0073148 A1
(43) Pub. Date: Mar. 10, 2016

(54) MEDIA CUSTOMIZATION BASED ON ENVIRONMENTAL SENSING

(71) Applicant: VERANCE CORPORATION, San Diego, CA (US)

(72) Inventors: Joseph M. Winograd, San Diego, CA (US); Donald L. Wenskay, San Diego, CA (US)

(21) Appl. No.: 14/849,452

(22) Filed: Sep. 9, 2015

Related U.S. Application Data
(60) Provisional application No. 62/048,207, filed on Sep. 9, 2014.

(51) Int. Cl. H04N 21/2668; H04N 21/2389; H04N 21/8358; H04N 21/44; H04N 21/422; H04N 21/4223; H04N 21/81; H04N 21/439; G06F 17/30; H04N 21/234

(52) U.S. Cl. CPC H04N 21/2668; G06F 17/30017; G06F 17/30752; G06F 17/3082; H04N 21/23892; H04N 21/8358; H04N 21/23418; H04N 21/42203; H04N 21/4223; H04N 21/812; H04N 21/4394; H04N 21/44008

(57) ABSTRACT

Methods, devices and computer program products facilitate management of multimedia content and recognition of a content that is being acoustically or optical presented using web-based technology. One method includes capturing an audio or a video content that is in acoustic or optical form via a microphone or a video camera that is coupled to an environmental sensing web-based mechanism integrated as part of a web page published by a server. Watermark or fingerprinting techniques are used to obtain identification information for the captured audio or the video content is produced, and based on the identification information, a customized response is received at the client device that includes a customized content or a customized information.

### CROSS REFERENCE TO RELATED APPLICATIONS

This application claims the benefit of priority of U.S. Provisional Patent Application No. 62/048,207, filed Sep. 9, 2014, the entire contents of which are incorporated by reference as part of the disclosure of this document.

### TECHNICAL FIELD

The subject matter of this patent document relates to management of multimedia content and more specifically to facilitating recognition and utilization of multimedia content.

### BACKGROUND

The use and presentation of multimedia content on a variety of mobile and fixed platforms have rapidly proliferated. By taking advantage of storage paradigms, such as cloud-based storage infrastructures, reduced form factor of media players, and high-speed wireless network capabilities, users can readily access and consume multimedia content regardless of the physical location of the users or the multimedia content. A multimedia content, such as an audiovisual content, can include a series of related images, which, when shown in succession, impart an impression of motion, together with accompanying sounds, if any. Such a content can be accessed from various sources including local storage such as hard drives or optical disks, remote storage such as Internet sites or cable/satellite distribution servers, over-the-air broadcast channels, etc.

In some scenarios, such a multimedia content, or portions thereof, may contain only one type of content, including, but not limited to, a still image, a video sequence and an audio clip, while in other scenarios, the multimedia content, or portions thereof, may contain two or more types of content such as audiovisual content and a wide range of metadata. The metadata can, for example include one or more of the following: channel identification, program identification, content and content segment identification, content size, the date at which the content was produced or edited, identification information regarding the owner and producer of the content, timecode identification, copyright information, closed captions, and locations such as URLs where advertising content, software applications, interactive services content, and signaling that enables various services, and other relevant data that can be accessed. In general, metadata is the information about the content essence (e.g., audio and/or video content) and associated services (e.g., interactive services, targeted advertising insertion).

Such metadata may be useful for several applications, such as identifying the content, broadcast verification, enabling broadcast interactive services, and others. However, such metadata which is often interleaved, prepended or appended to a multimedia content, occupies additional bandwidth and, more importantly, can be lost when content is transformed into a different format (such as digital to analog conversion, transcoded into a different file format, etc.), processed (such as transcoding), and/or transmitted in communication channel including acoustic and/or visual presentation of the multimedia content.

### BRIEF DESCRIPTION OF THE DRAWINGS

FIG. 1 illustrates a device that can be used for embedding of a watermark message in an object-based content in accordance with an exemplary embodiment.

FIG. 2 illustrates a set of operations that may be carried out to receive a customized content based on media environment sensing in accordance with an exemplary embodiment.

FIG. 3 illustrates another set of operations that may be carried out receive a customized content based on media environment sensing in accordance with an exemplary embodiment.

FIG. 4 illustrates another set of operations that may be carried out to receive a customized content based on media environment in accordance with an exemplary embodiment.

FIG. 5 illustrates a set of exemplary operations that can be carried out to provide a customized response based on media environment sensing in accordance with an exemplary embodiment.

FIG. 6 illustrates another set of exemplary operations that can be carried out to provide a customized response based on media environment sensing in accordance with an exemplary embodiment.

FIG. 7 illustrates a device that can be used for receiving a customized response based on media environment sensing in accordance with an exemplary embodiment.

FIG. 8 illustrates a block diagram of a device within which various disclosed embodiments may be implemented.

### SUMMARY OF CERTAIN EMBODIMENTS

The disclosed technology facilitates recognition of a content that is being presented in an acoustic or optical domain by using web-based audio and/or video mechanisms to capture and apply content identification techniques that utilize watermark extraction or fingerprint computation. The use of such integrated web-based technology eliminates a need to launch specialized applications or processes, and allows a larger number of users that are simply using or navigating the Internet to benefit from a variety of features that are enabled by such arrangement.

One aspect of the disclosed embodiments relates to a method that includes capturing an audio or a video content that is in acoustic or optical form at a client device's environment by using a microphone or a video camera that is coupled to an environmental sensing web-based mechanism integrated as part of a web page published by a server. The method further includes obtaining identification information for the captured audio or the video content, where the identification information has been produced by one or more automatic content recognition techniques comprising one or both of: (a) extracting a watermark from the audio or the video content that is being presented at the client device's environment, or (b) computing a fingerprint for one or more segments of the audio or the video content that is being presented at the client device's environment. The above noted method also includes, based on the identification information for the captured audio or the video content, receiving a customized response at the client device, where the customized response includes one or both of a customized content or a customized information.

In one exemplary embodiment, obtaining the identification information comprises extracting an embedded watermark from the captured audio or video content, or computing a fingerprint for the captured audio or video content, at the client device, and subsequently transmitting the extracted watermark or the computed fingerprint to the server. The audio or a video content that is being acoustically or optically presented at a client device's environment is identified at the server using a database of content identification information to obtain the identification information associated with the extracted watermark or the computed fingerprint. In another exemplary embodiment, the identification information includes transmitting the captured audio or video content to the server. In this embodiment, the audio or a video content that is being acoustically or optically presented at a client device's environment is identified at the server by extracting an embedded watermark or computing a fingerprint from the captured audio or video content, and using a database of content identification information to obtain the identification information associated with the extracted watermark or the computed fingerprint.

In one exemplary embodiment, obtaining the identification information includes extracting an embedded watermark from the captured audio or video content, or computing a fingerprint for the captured audio or video content, at the client device, and subsequently obtaining the identification information associated with the extracted watermark or the computed fingerprint using a database of content identification information local to the client device. In another exemplary embodiment, the identification information associated with the extracted watermark or the computed fingerprint is further transmitted to the server. In another exemplary embodiment, the identification information associated with the extracted watermark or the computed fingerprint is used to allow collection informational or market research information related to the captured audio or video content. In still another exemplary embodiment, the identification information associated with the extracted watermark or the computed fingerprint is used to allow collection of information regarding user exposure or user opinion of the identified audio or video content.

In yet another exemplary embodiment, the customized content includes an advertisement related to the audio or video content that is being acoustically or optically presented at a client device. In still another exemplary embodiment, the customized response includes the web page published by the server that is populated with particular items based on the identified audio or video content.

According to another exemplary embodiment, the above noted method further includes using the captured audio or video content to identify a location of the client device, where the customized response includes one or both of the customized content or the customized information based on the identified location information. In one exemplary embodiment, the captured audio or video content are identified as including an advertisement, and the customized response includes information related to a product or service of the advertisement. In another exemplary embodiment, the web page published by the server is a broadcaster web page, the captured audio or video content are identified as a particular program of the broadcaster, and the customized response includes information related to the identified program or a sponsor of the identified program. In still another exemplary embodiment, the web page published by the server is a broadcaster web page, the captured audio or video content are identified as a particular audio or video content from a source other than the broadcaster, and the customized response includes information related to a content that is similar to the audio or video content that is being acoustically or optically presented at the client device's environment in one or more of the following aspects: genre, duration, cost of purchase, cast members, director, date of release, or rating.

In one exemplary embodiment, the web page published by the server is a reference web page, the customized response includes the reference web page that is automatically populated with one or more of a search query or a search result associated with the identified audio or video content that is being acoustically or optically presented at the client device's environment. In another exemplary embodiment, the above noted method includes identifying an ambient sound or an ambient image from the captured audio or the captured video, and based on content of the identified ambient sound or ambient image or type of the identified ambient sound or ambient image, receiving additional information at the client device. In yet another exemplary embodiment, the additional information includes an advertisement for a product or service that is relevant to the identified ambient sound or ambient image.

Another aspect of the disclosed embodiments relates to a device that includes a processor and a memory comprising processor executable code. The processor executable code when executed by the processor causes the device to capture an audio or a video content that is being acoustically or optically presented at the device's environment by using a microphone or a video camera that is coupled to an environmental sensing web-based mechanism integrated as part of a web page published by a server. The processor executable code when executed by the processor further configures the device to obtain identification information for the captured audio or the video content, where the identification information has been produced by one or more automatic content recognition techniques comprising one or both of: (a) extracting a watermark from the audio or the video content that is being presented at the client device's environment, or (b) computing a fingerprint for one or more segments of the audio or the video content that is being presented at the device's environment. The processor executable code when executed by the processor also configures the device to receive a customized response at the client device that is customized based on the identification information for the captured audio or the video content, where the customized response includes one or both of a customized content or a customized information.

In one exemplary embodiment, the processor executable code when executed by the processor configures the device to extract an embedded watermark from the captured audio or video content, or compute a fingerprint for the captured audio or video content, at the device, and transmit the extracted watermark or the computed fingerprint to the server. In this embodiment, the audio or a video content that is being acoustically or optically presented at a device's environment is identified at the server using a database of content identification information to obtain the identification information associated with the extracted watermark or the computed fingerprint. In another exemplary embodiment, the processor executable code when executed by the processor configures the device to, as part of obtaining the identification information, transmit the captured audio or video content to the server, where the audio or a video content that is being acoustically or optically presented at a client device's environment is identified at the server by: (a) extracting an embedded watermark or computing a fingerprint from the captured audio or video content, and (b) using a database of content identification information to obtain the identification information associated with the extracted watermark or the computed fingerprint.

According to another exemplary embodiment, the processor executable code when executed by the processor configures the device to, as part of obtaining the identification information, (a) extract an embedded watermark from the captured audio or video content, or compute a fingerprint for the captured audio or video content, at the client device, and (b) obtain the identification information associated with the extracted watermark or the computed fingerprint using a database of content identification information local to the client device. In yet another exemplary embodiment, the processor executable code when executed by the processor further causes the device to, as part of obtaining the identification information, transmit the identification information associated with the extracted watermark or the computed fingerprint to the server.

In one exemplary embodiment, the processor executable code when executed by the processor configures the device to identify a location of the client device using the captured audio or video content, where the customized response includes one or both of the customized content or the customized information based on the identified location information. In another exemplary embodiment, the captured audio or video content are identified as including an advertisement, and the customized response includes information related to a product or service of the advertisement. In another exemplary embodiment, processor executable code when executed by the processor further configures the device to transmit the capture audio or video to a server, and receive additional information obtained based on content or type of an ambient sound or ambient image as identified from the captured audio or the captured video. In one example, the identification can be through fingerprinting or a speech or object recognition technique.

Another aspect of the disclosed embodiments relates to a computer program product, embodied on one or more non-transitory computer readable media, that includes program code for capturing an audio or a video content that is being acoustically or optically presented at a client device's environment by using a microphone or a video camera that is coupled to an environmental sensing web-based mechanism integrated as part of a web page published by a server. The computer program product further includes program code for obtaining identification information for the captured audio or the video content, where the identification information having been produced by one or more automatic content recognition techniques comprising one or both of: (a) extracting a watermark from the audio or the video content that is being presented at the client device's environment, or (b) computing a fingerprint for one or more segments of the audio or the video content that is being presented at the device's environment. The computer program product further includes program code for, based on the identification information for the captured audio or the video content, receiving a customized response at the client device, where the customized response includes one or both of a customized content or a customized information.

### DETAILED DESCRIPTION

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

Draft W3C standards such as “Web Audio API”, “Web Speech API”, and “Media Capture and Streams” have recently been published and implemented. These standards provide various types of support for a web page published by a server to access media signals captured on a client, such as via a microphone, still image camera, video camera, or internal audio or video path. In particular, Web Audio API includes is a high-level JavaScript API for processing and synthesizing audio in web applications. The primary paradigm in Web Audio API is of an audio routing graph, where a number of AudioNode objects are connected together to define the overall audio rendering. Web Speech API aims to provide an alternative input method for web applications (without using a keyboard). With this API, developers can give web applications the ability to, for example, transcribe a user's voice into text using the computer's microphone. The recorded audio is sent to speech servers for transcription, after which the text is typed out for viewing by the user.

In certain disclosed embodiments, automatic content recognition techniques are used in conjunction with browser-based audio capture and processing technologies to capture and recognize media content present in the environment of a client, and to provide customized content to the user based on the sensed environmental content. The media content present in the client environment can, for example, include movies, television programs, advertisements, radio broadcasts, public address system messages, billboards, signage, and the like. In some embodiments, the automatic content recognition techniques include watermarking and/or fingerprinting. Once such a media content in the client's environment is recognized, a web server can customize the content which it provides based on environmental content.

One automatic content recognition technique relies on embedded watermarks. Watermarks are substantially imperceptible signals embedded into a host content. The host content may be any one of audio, still image, video or any other content that may be stored on a physical medium or transmitted or broadcast from one point to another. Watermarks are designed to carry auxiliary information without substantially affecting fidelity of the host content, or without interfering with normal usage of the host content. For this reason, watermarks are sometimes used to carry out covert communications, where the emphasis is on hiding the very presence of the hidden signals. In addition, other widespread applications of watermarks include prevention of unauthorized usage (e.g., duplication, playing and dissemination) of copyrighted multimedia content, proof of ownership, authentication, tamper detection, content integrity verification, broadcast monitoring, transaction tracking, audience measurement, triggering of secondary activities such as interacting with software programs or hardware components, communicating auxiliary information about the content such as caption text, full title and artist name, or instructions on how to purchase the content, and the like. The above list of applications is not intended to be exhaustive, as many other present and future systems can benefit from co-channel transmission of main and auxiliary information.

In the context of the present application, watermarking techniques may be used to embed identifying information in a content that is present in a user's environment. The embedded watermarks are often associated with additional metadata the resides at a database. Such metadata provides additional information about the content (or a particular transaction related to the content), which may not be possible or practical to include as part of the watermark that is embedded in the content. The metadata can provide ownership information, copyright status, information about the content attributes (e.g., title or name, type, genre, resolution, etc.), or other information that may be useful in identifying the content.

Fingerprinting provides an alternate, or additional, technique for identifying the content. Fingerprinting techniques rely on inherent characteristics of a host content, rather then embedding a foreign signal, to identify a content. For example, a content may be divided into segments, and the number of peaks that exceed a predetermined threshold within each segment can be used to identify those content segments. A fingerprint can be computed based on a number of different content characteristics, or combinations thereof, such as based on energy profile, frequency distribution, color profiles, and others. In some fingerprinting techniques, a robust hash value of a content segment is computed that serves as the fingerprint for that particular segment. Fingerprinting techniques require a fingerprint database that is populated with fingerprints (usually on a segment-by-segment basis) associated with a particular content. In order to identify a content, the fingerprints from content segments are computed and compared against the registered fingerprints at the database to obtain a match. Different techniques for facilitating the search of the database can be used; these techniques often reduce the amount of information (or bandwidth) that is needed to be communicated to the data base and/or to speed up the search procedure for obtaining a positive identification, while at the same time, keep the level of false positive identifications to below a desired level.

The disclosed embodiments enable widespread adoption and usage of content recognition techniques by integrating recognition into web browsing, which is already a widespread behavior. Such integration eliminates a need to launch specialized applications or processes, and allows a larger number of users that are simply using or navigating the Internet to benefit from a variety of features that are enabled by such arrangement.

In one exemplary embodiment, a client that accesses any web site is presented with advertisements related to the recognized media content. In another exemplary embodiment, a web site records and recognizes the environmental audio and/or video content, based on automatic content recognition techniques, for informational or market research purposes.

In another exemplary embodiment, a client that accesses the web site of a retailer may be presented with different content depending on media content recognized in the client's environment. If a broadcast advertisement is recognized, the client may be presented with information related to the product being advertised. If content that is being played over the public address system of a particular location of the retailer is recognized, the client can be presented with information specific to that particular retail location. In particular, the captured environmental content can be identified using a content recognition technique, such as watermarking or fingerprinting. Once identified, location-specific information can be obtained using data that is stored at a database, or location-specific information using other techniques (e.g., GPS). When location information is obtained using metadata at a database, the database can include location information that ties a specific watermark value (or set of values) to a particular location. In case of fingerprinting, the database may include information that ties a specific content to a particular location.

In another exemplary embodiment, a client that accesses the web site of a broadcaster can be presented with different content depending on media content recognized in the client environment. The broadcaster web site can be a web site affiliated with a national broadcaster such as ABC, NBC, CBS, etc., or a web content provider, such as Netflix, Amazon Prime, etc., or any other local or national provider of content. If a particular program of the broadcaster that is being presented at the client's environment is identified, the client may be presented with information relating to that program or a sponsor/advertiser of the program. If an advertisement carried by the broadcaster is identified as part of the content that is being presented at the client's environment, the client may be presented with information relating to that advertiser. If a program of another broadcaster is identified, the client may be presented with information relating to similar programming carried by the broadcaster.

In another exemplary embodiment, a client that accesses a web site of a social media network can record and share, or offer to record and share, information about the client user's exposure to, or opinion of, the recognized content.

In another exemplary embodiment, a client that accesses a reference website (such as a content database, web search engine, or encyclopedia) may be presented with prepopulated search queries or search results that are associated with the content recognized to be present in the client environment.

In any of the above cases, the recognition information may be used in conjunction with other information, including geo-location information, information stored in cookies, information input by the user, information stored in databases referenced to or indexed by data stored in cookies, client identity, or other similar information to alter the content presented to the client by the web server.

The recognition may be performed in any or multiple of a number of ways. As noted earlier, one technique can include performing watermark detection on the captured content by the client and forwarding of results of the detection to a server. Another technique can include computing a fingerprint (e.g., computing inherent features and/or a robust hash of those features) of the captured content in the client and forwarding the computed fingerprint to a server for matching in a server against a database of fingerprints of known content. In one variation, instead of transmitting the fingerprint to a remote database, the computed fingerprints are matched against a database of fingerprints of known content in the client. In yet another variation, the captured content is sent to a server, and fingerprint computation and matching against the database of known content takes place at the remote server. One, or a combination of, the above techniques may be used depending on the computational resources and sophistication of the client, the available bandwidth of the communication link between the client and the server, and/or the level of access or changes that are allowed to take place at the client.

In some embodiments, additional ambient sounds are detected that facilitate the understanding of the user's environment or the user's characteristics. For example, in one embodiment, the ambient sound sensed by the microphone or the video camera includes a baby that is crying can trigger the insertion of advertisements related to baby products (e.g., diaper, formula milk, etc.). If the sensed video or audio includes a barking dog, for example, advertisements or search queries related to dog products (e.g., dog food) can be automatically populated on the website. The sensing of such ambient sounds/images can be carried out by (1) capturing the audio or video using a microphone or a camera, measuring inherent features of captured sounds such as performing sound/speech recognition on the captured content, identifying one or more specific sounds or images from the captured content, and automatically providing a specific item of interest based at least in-part of the identified sounds or images. Object recognition in the video and/or sound (and/or speech) recognition of the captured video can take place at the user device or at a server that is connected to the user device. Performing the image/sound recognition techniques at a server provides more flexibility in that more powerful computational and storage resources can be utilized in a localized or distributed manner. In some embodiments, the object/sound recognition enables identification of the contents or types of objects or sounds that are sensed. For example, using speech recognition allows the items of interest to be returned based on recognition of utterance of certain words.

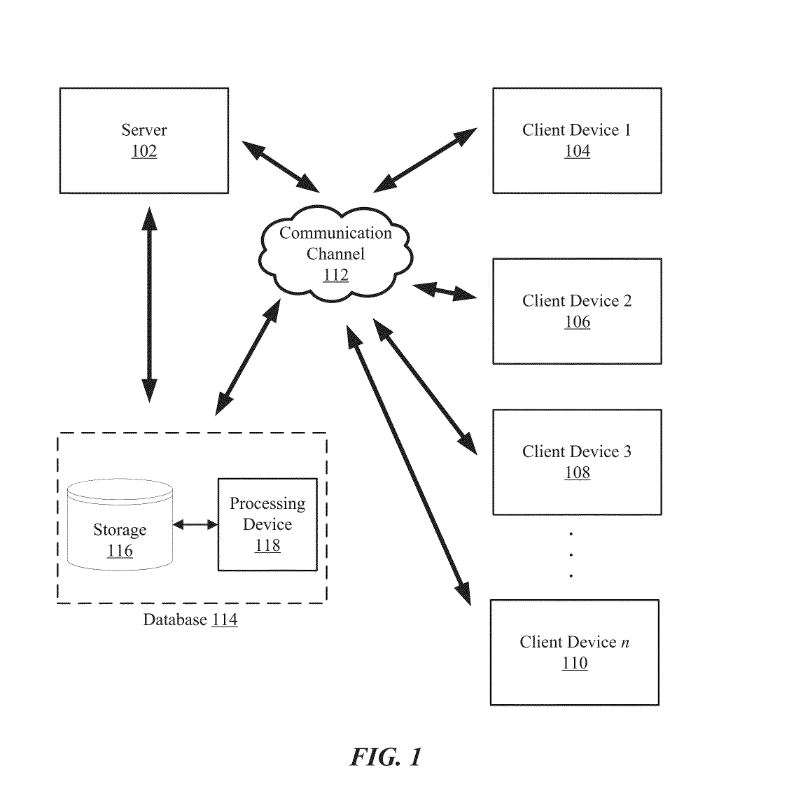

FIG. 1 is a block diagram of a system that can accommodate the disclosed embodiment. A server 102 is in communication with one or more client devices, such as client devices 1 through n, identified with reference numbers 104 to 110 in FIG. 1. The communication take places through a communication channel 112 (e.g., the Internet). The server 102 includes the appropriate components and modules to carry out part of the operations that are described in the present application. The server 102 and/or the client devices 104 to 110 can be in communication with, or include, a database 114, which comprises a storage 116 unit (or a number of storage units) and a processing device 118 for accessing and managing the storage 116 unit. The storage 116 can, for example, store metadata associated with particular content, links or associations between content identifiers and additional information, multimedia content, program codes, and other data or information.

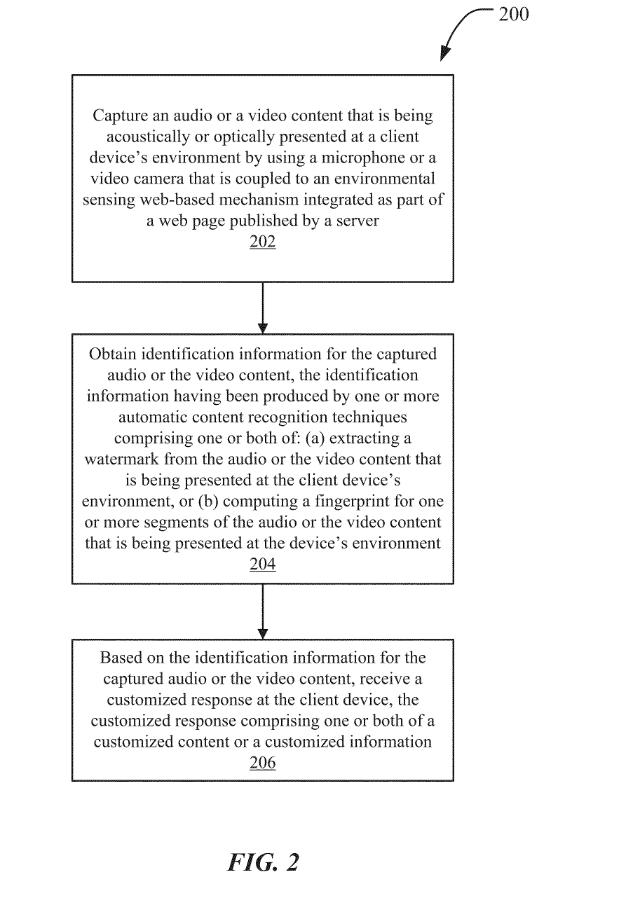

FIG. 2 illustrates a set of operations 200 that can be carried out to receive a customized content based on media environment sensing in accordance with an exemplary embodiment. At 202, an audio or a video content that is being acoustically or optically presented at a client device's environment is captured by a microphone or a video camera that is coupled to an environmental sensing web-based mechanism integrated as part of a web page published by a server. At 204, identification information associated with the captured audio or the video content is obtained, the identification information having been produced by one or more automatic content recognition techniques comprising one or both of: (a) extracting a watermark from the audio or the video content that is being presented at the client device's environment, or (b) computing a fingerprint for one or more segments of the audio or the video content that is being presented at the device's environment. At 206, based on the identification information for the captured audio or the video content, a customized response is received at the client device. Such a customized response includes one or both of a customized content or a customized information.

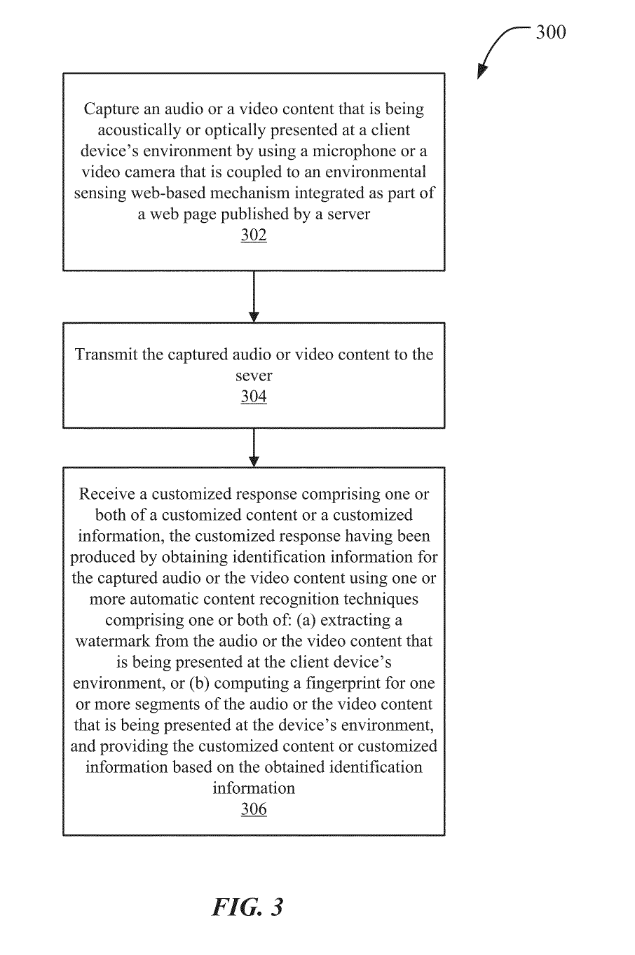

FIG. 3 illustrates another set of operations 300 that can be carried out to receive a customized content based on media environment sensing in accordance with an exemplary embodiment. At 302, an audio or a video content that is being acoustically or optically presented at a client device's environment is captured by a microphone or a video camera that is coupled to an environmental sensing web-based mechanism integrated as part of a web page published by a server. At 304, the captured audio or video content is transmitted to the sever. At 306, a customized response comprising one or both of a customized content or a customized information is received, the customized response having been produced by obtaining identification information for the captured audio or the video content using one or more automatic content recognition techniques comprising one or both of: (a) extracting a watermark from the audio or the video content that is being presented at the client device's environment, or (b) computing a fingerprint for one or more segments of the audio or the video content that is being presented at the device's environment, and providing the customized content or customized information based on the obtained identification information.

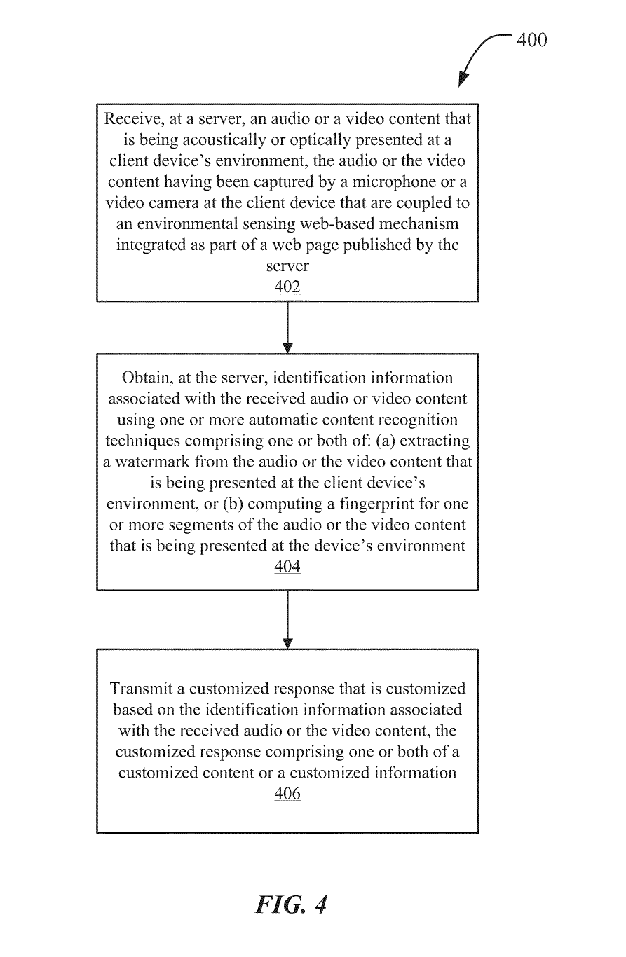

FIG. 4 illustrates another set of operations 400 that can be carried out to receive a customized content based on media environment sensing in accordance with an exemplary embodiment. At 402, an audio or a video content that is being acoustically or optically presented at a client device's environment is received at a server, the audio or the video content having been captured by a microphone or a video camera at the client device that are coupled to an environmental sensing web-based mechanism integrated as part of a web page published by the server. At 404, identification information associated with the received audio or video content is obtained at the server using one or more automatic content recognition techniques comprising one or both of: (a) extracting a watermark from the audio or the video content that is being presented at the client device's environment, or (b) computing a fingerprint for one or more segments of the audio or the video content that is being presented at the device's environment. At 406, a customized response that is customized based on the identification information associated with the received audio or the video content is transmitted, where the customized response includes one or both of a customized content or a customized information. Such a response can be received by the client device that was used to capture the audio or video content to enable presentation of such a customized content, or customized information at the client device.

One aspect of the disclosed technology relates to a device that includes a processor, and a memory comprising processor executable code. The processor executable code when executed by the processor configures the device to receive an audio or a video content that is being acoustically or optically presented at the device's environment, the audio or the video content having been captured by a microphone or a video camera at the client device that are coupled to an environmental sensing web-based mechanism integrated as part of a web page published by the server. The processor executable code when executed by the processor further configures the device to obtain, at the server, identification information associated with the received audio or video content using one or more automatic content recognition techniques comprising one or both of: (a) extracting a watermark from the audio or the video content that is being presented at the client device's environment, or (b) computing a fingerprint for one or more segments of the audio or the video content that is being presented at the device's environment. The processor executable code when executed by the processor further configures the device to transmit a customized response that is customized based on the identification information for the received audio or the video content, the customized response comprising one or both of a customized content or a customized information.

Another aspect of the disclosed technology relates to a computer program product, embodied on one or more non-transitory computer readable media, that includes program code for receiving, at a server, an audio or a video content that is being acoustically or optically presented at a client device's environment, the audio or the video content having been captured by a microphone or a video camera at the client device that are coupled to an environmental sensing web-based mechanism integrated as part of a web page published by the server. The computer program product further includes program code for obtaining, at the server, identification information associated with the received audio or video content using one or more automatic content recognition techniques comprising one or both of: (a) extracting a watermark from the audio or the video content that is being presented at the client device's environment, or (b) computing a fingerprint for one or more segments of the audio or the video content that is being presented at the device's environment. The computer program product also includes program code for transmitting a customized response that is customized based on the identification information associated with the received audio or the video content, where the customized response includes one or both of a customized content or a customized information.

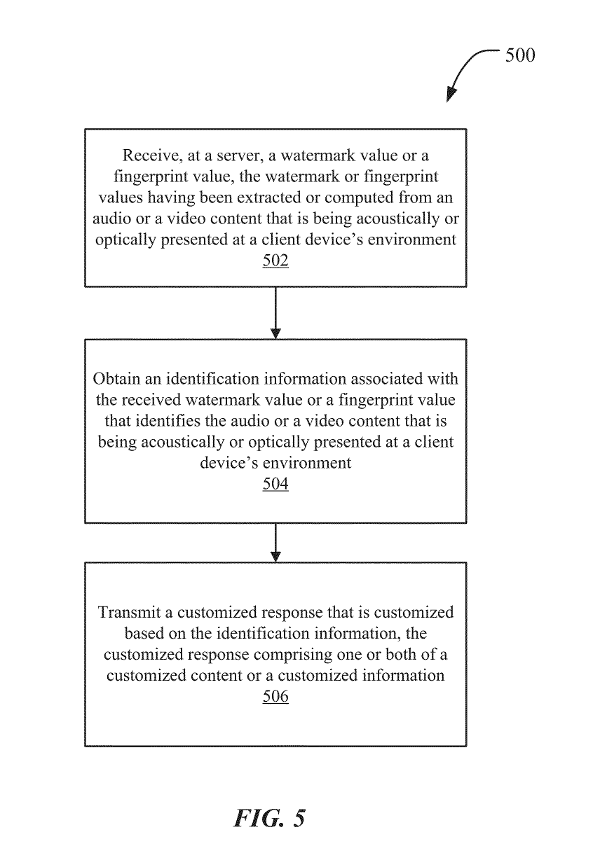

FIG. 5 illustrates a set of exemplary operations 500 that can be carried out to provide a customized response based on media environment sensing in accordance with an exemplary embodiment. At 502, a watermark value or a fingerprint value is received at a server, the watermark or fingerprint values having been extracted or computed from an audio or a video content that is being acoustically or optically presented at a client device's environment. At 504, an identification information associated with the received watermark value or a fingerprint value is obtained that identifies the audio or a video content that is being acoustically or optically presented at a client device's environment. At 506, a customized response that is customized based on the identification information is transmitted, where the customized response includes one or both of a customized content or a customized information.

One aspect of the disclosed embodiments relates to a server device that includes a processor and a memory comprising processor executable code. The processor executable code, when executed by the processor, configures the server device to receive a watermark value or a fingerprint value, the watermark or fingerprint value having been extracted or computed from an audio or a video content that is being acoustically or optically presented at a client device's environment. The processor executable code, when executed by the processor, also configures the server device to obtain an identification information associated with the received watermark value or a fingerprint value that identifies the audio or a video content that is being acoustically or optically presented at the client device's environment, and transmit a customized response that is customized based on the identification information. The customized response includes one or both of a customized content or a customized information.

Another aspect of the disclosed embodiments relates to a computer program product, embodied on one or more non-transitory computer readable media, that includes program code for receiving, at a server, a watermark value or a fingerprint value, the watermark or the fingerprint value having been extracted or computed from an audio or a video content that is being acoustically or optically presented at a client device's environment. The computer program product also includes program code for obtaining an identification information associated with the received watermark value or a fingerprint value that identifies the audio or a video content that is being acoustically or optically presented at the client device's environment, as well as program code for transmitting a customized response that is customized based on the identification information, where the customized response includes one or both of a customized content or a customized information

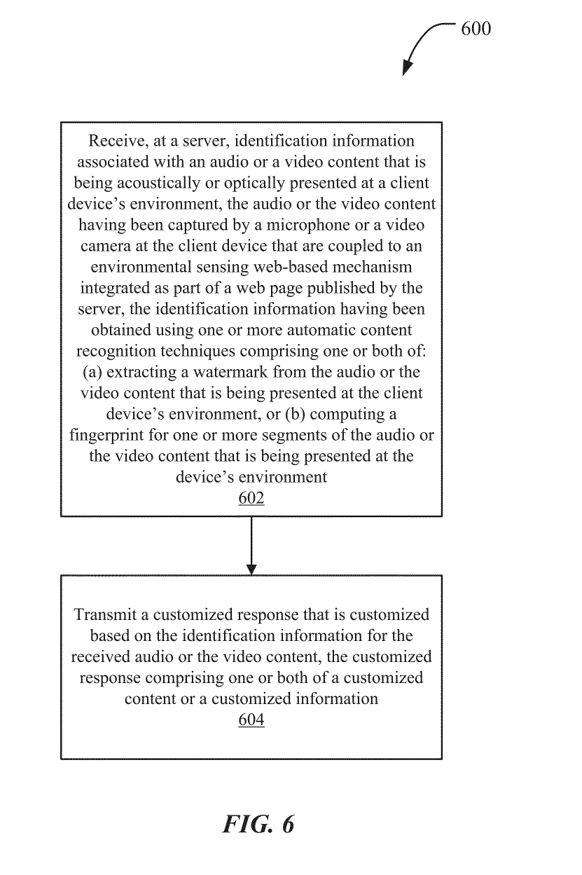

FIG. 6 illustrates a set of exemplary operations 600 that can be carried out to provide a customized response based on media environment sensing in accordance with an exemplary embodiment. At 602, identification information associated with an audio or a video content that is being acoustically or optically presented at a client device's environment is received at a server. In this content, the audio or the video content were captured by a microphone or a video camera at the client device that are coupled to an environmental sensing web-based mechanism integrated as part of a web page published by the server. The identification information having been obtained using one or more automatic content recognition techniques comprising one or both of: (a) extracting a watermark from the audio or the video content that is being presented at the client device's environment, or (b) computing a fingerprint for one or more segments of the audio or the video content that is being presented at the device's environment. At 604, a customized response that is customized based on the identification information for the received audio or the video content is transmitted. The customized response include one or both of a customized content or a customized information.

Another aspect of the disclosed technology relates to a server device that includes a processor and a memory comprising processor executable code. The processor executable code, when executed by the processor, configures the server device to receive identification information associated with an audio or a video content that is being acoustically or optically presented at a client device's environment, the audio or the video content having been captured by a microphone or a video camera at the client device that are coupled to an environmental sensing web-based mechanism integrated as part of a web page published by the server. The identification information has been obtained using one or more automatic content recognition techniques comprising one or both of: (a) extracting a watermark from the audio or the video content that is being presented at the client device's environment, or (b) computing a fingerprint for one or more segments of the audio or the video content that is being presented at the device's environment. The processor executable code, when executed by the processor, further configures the server device to transmit a customized response that is customized based on the identification information for the received audio or the video content, where the customized response includes one or both of a customized content or a customized information.

Another aspect of the disclosed embodiments relates to a computer program product, embodied on one or more non-transitory computer readable media, that includes program code for receiving, at a server, identification information associated with an audio or a video content that is being acoustically or optically presented at a client device's environment. The audio or the video content has been captured by a microphone or a video camera at the client device that are coupled to an environmental sensing web-based mechanism integrated as part of a web page published by the server, and the identification information has been obtained using one or more automatic content recognition techniques comprising one or both of: (a) extracting a watermark from the audio or the video content that is being presented at the client device's environment, or (b) computing a fingerprint for one or more segments of the audio or the video content that is being presented at the device's environment. The computer program product further includes program code for transmitting a customized response that is customized based on the identification information for the received audio or the video content, where the customized response includes one or both of a customized content or a customized information.

In some embodiments, a history of the sensed ambient media can be stored to create a profile for each user (or household) based on an aggregation of several factors, such as how much TV (and which shows) a user listen to or watched, how much music the user listened to, which radio stations the user listened to, etc. The aggregation of user-specific information can be performed at a remote entity, such as the servers that host the website, at and advertisement exchange that takes and accepts bids from sponsors for placement of advertisements.

One example implementation of the disclosed embodiments incorporates some of the features of HTML5 technology for capturing the audio and/or video that is being presented in a user's environment as part of a web browsing activity. For instance, HTML5 function getUserMedia( ) can be used in a web page to request that the web page script be provided with the ability to receive and process audio and/or video from a microphone or camera of a device. A script can include instructions for processing the audio or video sensed in the environment to identify visual or auditory content. For example, if a client is accessing, e.g., the Amazon webpage using an HTML5 compatible browser on a device while a TV is on in the room, the Amazon webpage can include a script which activates the audio or video input on the client's device, identifies programs or advertisements which are being presented on the television set from the content received through this input, and presents, on the webpage, offers or information related to what is on the TV (e.g. clothing that a character is wearing, products that are being advertised, etc.). Appendix A at the end of this document provides an example script for using the getUserMedia function.

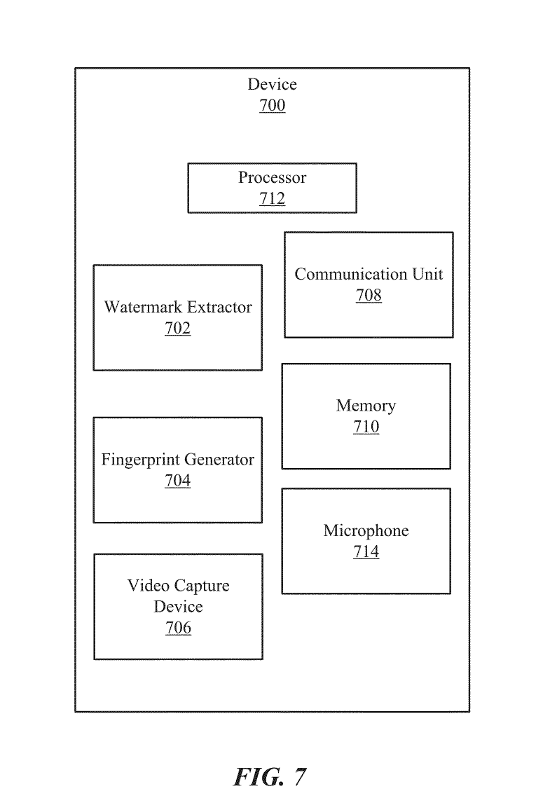

FIG. 7 illustrates a device 700 that can be used for receiving a customized response based on media environment sensing in accordance with an exemplary embodiment. The device 700 can include a processor 712 that performs various operations including management of data and information flow among different components of the device 700 and between the device and one or more external devices. The device 700 also includes a memory 710, which can be used for storage of content, information, data, program code and any other information that requires storage or buffering at the device 700. While only one memory 710 is shown, the device 700 can include more than one memory such as a hard disk, RAM, ROM, optical storage, magnetic storage and other types of volatile or non-volatile storage devices.

The communication unit 708 allows the device to send or receive data, information and other signals to and from other devices, or other components. The communication unit 708 may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information. The processor 712 and memory 710 can be coupled to each other and to all other components of the device 700. In some embodiments, the processor 712 can initialize the various components of the device 700, load or configure those components with operating parameters, or program codes, or logic gate configurations and/or facilitate communication of data and other information among those components.

The device 700 can also include a watermark extractor 702. The watermark extractor can, for example, be coupled to a microphone 714 or a video capture device 706 to receive audio and video content, and perform watermark detection. The device can also include a fingerprint generator 704. The fingerprint generator 704 can, for example, be coupled to a microphone 714 or a video capture device 706 to receive audio and video content, and perform watermark detection. The fingerprint generator 704 can also be coupled to database (e.g., an external database, or a database that resides in memory 710) to compare the generated fingerprints to a set of registered fingerprints in order to obtain content identification information. Such a database may also contain meta data that allows obtaining the content identification information based on watermarks that are extracted by the watermark extractor 702.

In some embodiments, device 700 can be configured to allow one or more of the audio content captured by the microphone 714, the video content captured by the video capture device 706, the extracted watermark value(s) provided by the watermark extractor 702, the fingerprint values generated by the fingerprint generator 704, or the identification information obtained based on the extracted watermarks or computed fingerprints to be transmitted to a server via the communication unit 708. The communication unit 708 also enables the device to receive a response, including a customized content or customized information, from the server.

The device 700 may include additional or fewer components as needed to carry out the disclosed operations. The device 700 may be a standalone device, or may be implemented as part of another device, such as a content handling device capable of receiving a content. Non-exhaustive examples of such devices include personal computers, laptops, tablets, mobile handheld devices such as smart phone, television sets or set-top boxes.

The device 700 may also be implemented at a server. In such an implementation, the device 700 may not include the microphone 714, or the video capture device 706 since audio/video capture takes place at the client side.

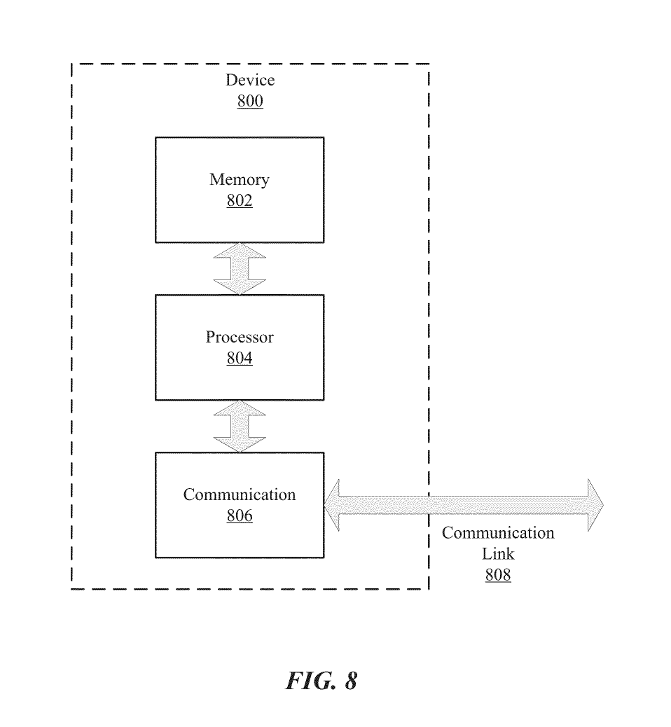

In some examples, the devices that are described in the present application can comprise a processor, a memory unit, and an interface that are communicatively connected to each other, and may range from desktop and/or laptop computers, to consumer electronic devices such as media players, mobile devices and the like. For example, FIG. 8 illustrates a block diagram of a device 800 within which various disclosed embodiments may be implemented. The device 800 comprises at least one processor 802 and/or controller, at least one memory 804 unit that is in communication with the processor 802, and at least one communication unit 806 that enables the exchange of content, data and information, directly or indirectly, through the communication link 808 with other entities, devices, databases and networks. The communication unit 806 may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information. The exemplary device 800 that is depicted in FIG. 8 may be integrated into as part of a content handling device, or at a server, that can receive a content and conduct the various operations that are described in the present application, such as those operations illustrated in FIGS. 2-6.

It is understood that the various disclosed embodiments can be implemented individually, or collectively, in devices comprised of various hardware and/or software modules and components, or as a combination of hardware and software. In particular embodiments, a hardware implementation can include discrete analog and/or digital circuits that are, for example, integrated as part of a printed circuit board. Alternatively, or additionally, in particular embodiments, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application.

In describing the disclosed embodiments, sometimes separate components have been illustrated as being configured to carry out one or more operations. It is understood, however, that two or more of such components can be combined together and/or each component may comprise sub-components that are not depicted. Further, the operations that are described in various figures of the present application are presented in a particular sequential order in order to facilitate the understanding of the underlying concepts. It is understood, however, that such operations may be conducted in a different sequential order, and further, additional or fewer steps may be used to carry out the various disclosed operations.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM). Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

### APPENDIX A

Example Script showing usage of getUserMedia function of HTML5. In the example provided in Appendix A, “constraints” is the media types that support the LocalMediaStream object returned in the successCallback. The constraints parameter can be a MediaStreamConstraints object with two Boolean members: video and audio. These describe the media types supporting the LocalMediaStream object, and either or both is specified to validate the constraint argument; “successCallback” is the function on the calling application to invoke when passing the LocalMediaStream object; “errorCallback” is function on the calling application to invoke if the call fails.

• Calling syntax:

navigator.getUserMedia(constraints, successCallback, errorCallback);

• Example of using getUserMedia( ) with various browsers'
prefixes

navigator.getUserMedia = ( navigator.getUserMedia ∥

```
  navigator.webkitGetUserMedia ∥
  navigator.mozGetUserMedia ∥
  navigator.msGetUserMedia);
```

if (navigator.getUserMedia) {
navigator.getUserMedia (

```
// constraints
{
  video: true,
  audio: true
},
// successCallback
function(localMediaStream) {
  var video = document.querySelector(‘video’);
  video.src = window.URL.createObjectURL(localMediaStream);
  // Do something with the video here, e.g. video.play( )
},
// errorCallback
function(err) {
  console.log(“The following error occured: ” + err);
}
```

```
  );
} else {
  console.log(“getUserMedia not supported”);
}.
```

What is claimed is:

1. A method, comprising:
capturing an audio or a video content that is in acoustic or optical form at a client device's environment by using a microphone or a video camera that is coupled to an environmental sensing web-based mechanism integrated as part of a web page published by a server;
obtaining identification information for the captured audio or the video content, the identification information having been produced by one or more automatic content recognition techniques comprising one or both of: (a) extracting a watermark from the audio or the video content that is being presented at the client device's environment, or (b) computing a fingerprint for one or more segments of the audio or the video content that is being presented at the client device's environment; and
based on the identification information for the captured audio or the video content, receiving a customized response at the client device, the customized response comprising one or both of a customized content or a customized information.

2. The method of claim 1, wherein obtaining the identification information comprises:
extracting an embedded watermark from the captured audio or video content, or computing a fingerprint for the captured audio or video content, at the client device; and
transmitting the extracted watermark or the computed fingerprint to the server, wherein the audio or a video content that is being acoustically or optically presented at a client device's environment is identified at the server using a database of content identification information to obtain the identification information associated with the extracted watermark or the computed fingerprint.

3. The method of claim 1, wherein obtaining the identification information comprises:
transmitting the captured audio or video content to the server, wherein the audio or a video content that is being acoustically or optically presented at a client device's environment is identified at the server by extracting an embedded watermark or computing a fingerprint from the captured audio or video content, and using a database of content identification information to obtain the identification information associated with the extracted watermark or the computed fingerprint.

4. The method of claim 1, wherein obtaining the identification information comprises:
extracting an embedded watermark from the captured audio or video content, or computing a fingerprint for the captured audio or video content, at the client device; and
obtaining the identification information associated with the extracted watermark or the computed fingerprint using a database of content identification information local to the client device.

5. The method of claim 1, wherein the identification information associated with the extracted watermark or the computed fingerprint is used to allow collection of informational or market research information related to the captured audio or video content.

6. The method of claim 1, wherein the identification information associated with the extracted watermark or the computed fingerprint is used to allow collection of information regarding user exposure or user opinion of the identified audio or video content.

7. The method of claim 1, wherein the customized content includes an advertisement related to the audio or video content that is being acoustically or optically presented at a client device.

8. The method of claim 1, wherein the customized response includes the web page published by the server that is populated with particular items based on the identified audio or video content.

9. The method of claim 1, further comprising using the captured audio or video content to identify a location of the client device, wherein the customized response includes one or both of the customized content or the customized information based on the identified location information.

10. The method of claim 1, wherein:
the captured audio or video content are identified as including an advertisement; and
the customized response includes information related to a product or service of the advertisement.

11. The method of claim 1, wherein:
the web page published by the server is a broadcaster web page;
the captured audio or video content are identified as a particular program of the broadcaster; and
the customized response includes information related to the particular program or a sponsor of the particular program.

12. The method of claim 1, wherein:
the web page published by the server is a broadcaster web page;
the captured audio or video content are identified as a particular audio or video content from a source other than the broadcaster; and
the customized response includes information related to a content that is similar to the audio or video content that is being acoustically or optically presented at the client device's environment in one or more of the following aspects: genre, duration, cost of purchase, cast members, director, date of release, or rating.

13. The method of claim 1, wherein:
the web page published by the server is a reference web page;
the customized response includes the reference web page that is automatically populated with one or more of a search query or a search result associated with the identified audio or video content that is being acoustically or optically presented at the client device's environment.

14. The method of claim 1, comprising:
identifying an ambient sound or an ambient image from the captured audio or the captured video; and
based on content of the identified ambient sounds or ambient image or type of the identified ambient sound or ambient image, receiving additional information at the client device.

15. A device, comprising:
a processor, and
a memory comprising processor executable code, the processor executable code when executed by the processor configures the device to:
capture an audio or a video content that is being acoustically or optically presented at the device's environment by using a microphone or a video camera that is coupled to an environmental sensing web-based mechanism integrated as part of a web page published by a server;
obtain identification information for the captured audio or the video content, the identification information having been produced by one or more automatic content recognition techniques comprising one or both of: (a) extracting a watermark from the audio or the video content that is being presented at the client device's environment, or (b) computing a fingerprint for one or more segments of the audio or the video content that is being presented at the device's environment; and
receive a customized response at the device that is customized based on the identification information for the captured audio or the video content, the customized response comprising one or both of a customized content or a customized information.

16. The device of claim 15, wherein the processor executable code when executed by the processor configures the device to:
extract an embedded watermark from the captured audio or video content, or compute a fingerprint for the captured audio or video content; and
transmit the extracted watermark or the computed fingerprint to the server, wherein the audio or a video content that is being acoustically or optically presented at the device's environment is identified at the server using a database of content identification information to obtain the identification information associated with the extracted watermark or the computed fingerprint.

17. The device of claim 15, the processor executable code when executed by the processor configures the device to:
transmit the captured audio or video content to the server, wherein the audio or a video content that is being acoustically or optically presented at the device's environment is identified at the server by extracting an embedded watermark or computing a fingerprint from the captured audio or video content, and using a database of content identification information to obtain the identification information associated with the extracted watermark or the computed fingerprint.

18. The device of claim 15, wherein the processor executable code when executed by the processor configures the device to:
extract an embedded watermark from the captured audio or video content, or compute a fingerprint for the captured audio or video content; and
obtain the identification information associated with the extracted watermark or the computed fingerprint using a database of content identification information local to the device.

19. The device of claim 15, wherein the identification information associated with the extracted watermark or the computed fingerprint is used to allow collection informational or market research information related to the captured audio or video content.

20. The device of claim 15, wherein the identification information associated with the extracted watermark or the computed fingerprint is used to allow collection of information regarding user exposure or user opinion of the identified audio or video content.

21. The device of claim 15, wherein the customized content includes an advertisement related to the audio or video content that is being acoustically or optically presented at the device.

22. The device of claim 15, wherein the customized response includes the web page published by the server that is populated with particular items based on the identified audio or video content.

23. The device of claim 15, wherein the processor executable code when executed by the processor configures the device to identify a location of the device using the captured audio or video content, wherein the customized response includes one or both of the customized content or the customized information based on the identified location information.

24. The device of claim 15, wherein:
the captured audio or video content are identified as including an advertisement; and
the customized response includes information related to a product or service of the advertisement.

25. The device of claim 15, wherein:
the web page published by the server is a broadcaster web page;
the captured audio or video content are identified as a particular program of the broadcaster; and
the customized response includes information related to the identified program or a sponsor of the identified program.

26. The device of claim 15, wherein:
the web page published by the server is a broadcaster web page;
the captured audio or video content are identified as a particular audio or video content from a source other than the broadcaster; and
the customized response includes information related to a content that is similar to the audio or video content that is being acoustically or optically presented at the device's environment in one or more of the following aspects: genre, duration, cost of purchase, cast members, director, date of release, or rating.

27. The device of claim 15, wherein:
the web page published by the server is a reference web page;
the customized response include the reference web page that is automatically populated with one or a search query or a search result associated with the identified audio or video content that is being acoustically or optically presented at the device's environment.

28. The device of claim 15, wherein the processor executable code when executed by the processor configures the device to:
transmit the captured audio or video to the server; and
receive additional information obtained based on content or type of an ambient sound or ambient image identified from the captured audio or the captured video.

29. A computer program product, embodied on one or more non-transitory computer readable media, comprising:
program code for capturing an audio or a video content that is being acoustically or optically presented at a client device's environment by using a microphone or a video camera that is coupled to an environmental sensing web-based mechanism integrated as part of a web page published by a server;
program code for obtaining identification information for the captured audio or the video content, the identification information having been produced by one or more automatic content recognition techniques comprising one or both of: (a) extracting a watermark from the audio or the video content that is being presented at the client device's environment, or (b) computing a fingerprint for one or more segments of the audio or the video content that is being presented at the device's environment; and
program code for, based on the identification information for the captured audio or the video content, receiving a customized response at the client device, the customized response comprising one or both of a customized content or a customized information.
